(19) United States
(12) Patent Application Publication
(10) Pub. No.: US 2004/0120798 A1
(43) Pub. Date: Jun. 24, 2004

(54) Cadaver manipulation system and method

(76) Inventors: David T. Davis, Bethlehem, PA (US); Matthew Dudonis, Columbia, MD (US)

Correspondence Address: SAMUEL W. APICELLI, DUANE MORRIS LLP, 305 NORTH FRONT STREET, P.O. BOX 1003, HARRISBURG, PA, 17108-1003, US

(21) Appl. No.: 10/323,459

(22) Filed: Dec. 18, 2002

(51) Int. Cl. B66C 1/66

(52) U.S. Cl. 414/268

(57) ABSTRACT

A system and method for storing and manipulating cadavers in a storage compartment includes a frame erected within the storage compartment having a plurality of trays supported on the frame so as to project inwardly into the storage compartment. Each of the trays is supported upon a pair of spaced-apart telescoping arms so that each tray can be moved between (i) a first position wherein the telescoping arms supporting the tray are fully retracted, and (ii) a second position wherein the telescoping arms are fully extended. A hoist assembly is arranged so as to raise one of the cadavers when the tray is in the first position, and lower the cadaver onto the tray when the telescoping arms are in the second position. A method for manipulating a cadaver is also provided in which a cadaver is first positioned on a pallet or morgue tray for transportation to a storage compartment. The pallet or morgue tray and cadaver are then lifted within the storage compartment to a position above a selected pair of telescoping arms. The selected pair of telescoping arms are pulled outwardly, away from the wall of the storage compartment so as to extend to a position substantially under the pallet or morgue tray. The pallet or morgue tray and cadaver are then lowered onto the pair of telescoping arms. With the pallet or morgue tray and cadaver safely positioned atop the pair of telescoping arms, they are pushed toward the wall of the compartment so as to collapse the telescoping arms supporting the tray. This procedure can be repeated until a plurality of trays are loaded with cadaver each.

### FIELD OF THE INVENTION

The present invention generally relates to refrigerated storage and, more particularly, to the manipulation of cadavers within refrigerated storage facilities.

### BACKGROUND OF THE INVENTION

It is well known that hospitals and mortuaries utilize refrigerated compartments to store cadavers. This is necessary to preserve the body and prolong the natural decomposition process which would normally take place without refrigeration. Some prior art cadaver refrigeration units have utilized individual refrigerated lockers, each equipped with a telescoping tray assembly so that each cadaver may be stored on an individual tray within an individual compartment of the refrigeration unit. A cadaver is removed from such prior art assemblies by being physically lifted from the extended tray and then placed onto a cart. A reversed procedure is used when the cadaver is to be placed in the refrigeration unit. Such activities can often be the cause of work related injuries, especially in cases where the cadaver to be moved is heavy. Moreover, damage to the cadaver may occur if it is dropped during such handling. In addition, such prior art systems are space consuming and therefore expensive to implement in hospitals and mortuaries.

Numerous other refrigerated systems and storage devices are known in the art for use with cadavers in a post mortem setting. For example, U.S. Pat. No. 143,059 issued to Camp on Sep. 23, 1873, discloses a refrigerator which is constructed such that the interior parts may be readily removed for cleaning. The refrigerator includes a hollow perforated shaft with four-armed plates or spiders and a plurality of swinging shelves. The shelves are pivotally mounted to the four-armed plates so that items may be placed or removed from the shelves.

U.S. Pat. No. 5,586,816, issued to Geiss on Dec. 24, 1996, discloses a mobile storage cabinet in combination with a shelf structure that is horizontally and vertically adjustable with respect to the cabinet. The shelf structure comprises an inner cabinet having vertically spaced, slidingly mounted shelves. In the stored position, the inner cabinet including the shelves, rests inside the outer cabinet beneath the top surface. In an extended position, the inner cabinet rests forwardly of the outer cabinet and may be further moved vertically between fully lowered and raised positions. A unitary shelf is also disclosed that is horizontally and vertically adjustable with respect to the cabinet. This unitary shelf embodiment may be used as a cadaver work table in funeral homes and morgues.

U.S. Pat. No. 5,924,580, issued to Chase on Jul. 20,1999, discloses a rotational cadaver system which incorporates a rotational storage rack. The rotational storage rack includes a first and second shaft and two wheels mounted thereto. The shaft is rotationally mounted on a plurality of legs. A number of branches are radially secured to each wheel and arms are pivotally secured to each branch. The arms include means for receiving a tray upon which a cadaver may be placed. The trays include means for engagement with mechanical placement and retrieval means. The tray also includes means for securing the trays to various types of autopsy tables. A motor is also provided for turning the shaft thereby varying the position of the cadavers. A method is also disclosed for utilizing the system in conjunction with the performance of an autopsy.

None of the foregoing prior art cadaver handling systems is fully satisfactory. Accordingly, there is a need for a system that allows for the efficient storage, manipulation, and retrieval of cadavers from a refrigerated storage facility.

### SUMMARY OF THE INVENTION

The present invention provides a system and method for storing and manipulating cadavers in a storage compartment. The invention includes a frame erected within the storage compartment and one or more trays supported on the frame so as to project inwardly into the storage compartment. Each tray is supported by a pair of spaced-apart telescoping arms so that each tray can be moved between (i) a first position wherein the telescoping arms are fully retracted, and (ii) a second position wherein the telescoping arms are fully extended. A hoist assembly is arranged so as to raise one of the cadavers when the telescoping arms are in the first position, and lower the cadaver when the telescoping arms are in the second position. The trays may be either permanently mounted to the telescoping arms or be separate, removable structures that are placed upon and supported by the telescoping arms.

A method for manipulating a cadaver is also provided in which a cadaver is first positioned on a pallet for transportation to a storage compartment. The pallet may comprise a sling or a morgue tray. The pallet and cadaver are then lifted within the storage compartment to a position above a selected pair of telescoping arms. The selected pair of telescoping arms are pulled outwardly, away from the wall of the storage compartment so as to extend to a position substantially under the pallet. The pallet and cadaver are then lowered onto the selected pair of telescoping arms. With the pallet and cadaver safely positioned atop the selected pair of telescoping arms, it is pushed toward the wall of the compartment so as to collapse the telescoping arms supporting the pallet. This procedure can be repeated until a plurality of pallets are loaded with cadavers.

### BRIEF DESCRIPTION OF THE DRAWINGS

These and other features and advantages of the present invention will be more fully disclosed in, or rendered obvious by, the following detailed description of the preferred embodiments of the invention, which are to be considered together with the accompanying drawings wherein like numbers refer to like parts and further wherein:

FIG. 1 is a perspective view of a cadaver manipulation system formed in accordance with the present invention;

FIG. 2 is a rear elevational view of the cadaver manipulation system shown in FIG. 1;

FIG. 3 is an exploded perspective view of an extendible, telescoping arm assembly formed in accordance with the present invention;

FIG. 4 is a broken-way perspective view of a portion of the cadaver manipulation system shown in FIG. 1;

FIG. 5 is a partially broken away, rear elevational view of a cadaver manipulation system formed in accordance with the present invention, including a cart carrying a cadaver;

FIG. 6 is a perspective view of a frame formed in accordance with the present invention;

FIG. 7 is a perspective view of a pallet formed in accordance with the present invention;

FIG. 8 is a perspective view of a sling assembly formed in accordance with the present invention;

FIGS. 9-12 are rear elevational views, partially broken away, of a cadaver manipulation system formed in accordance with the present invention showing, in serial, the steps of one embodiment of the method of the invention; and

FIGS. 13-14 are rear elevational views, partially broken away, of a cadaver manipulation system formed in accordance with an alternative embodiment of the present invention showing.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

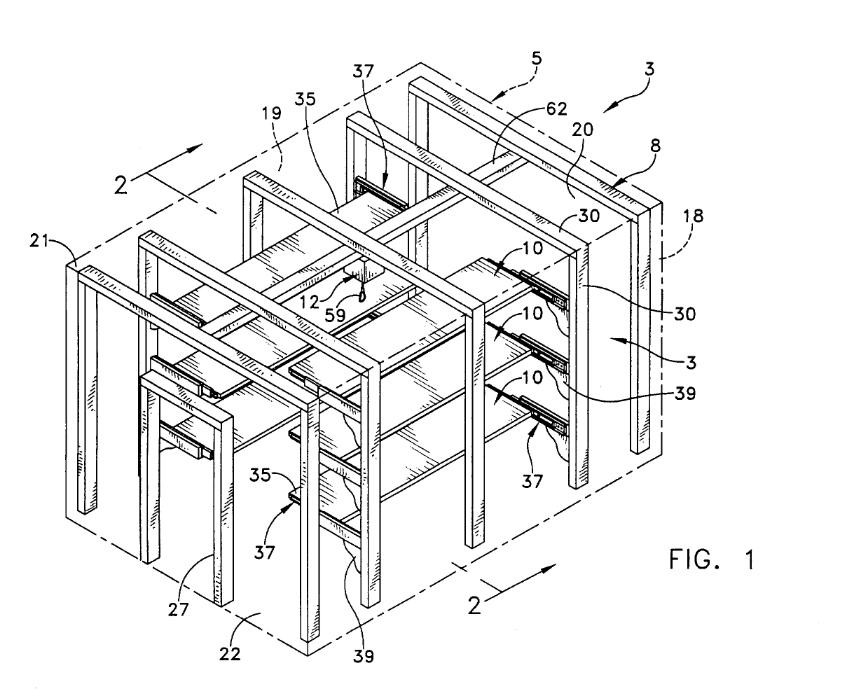

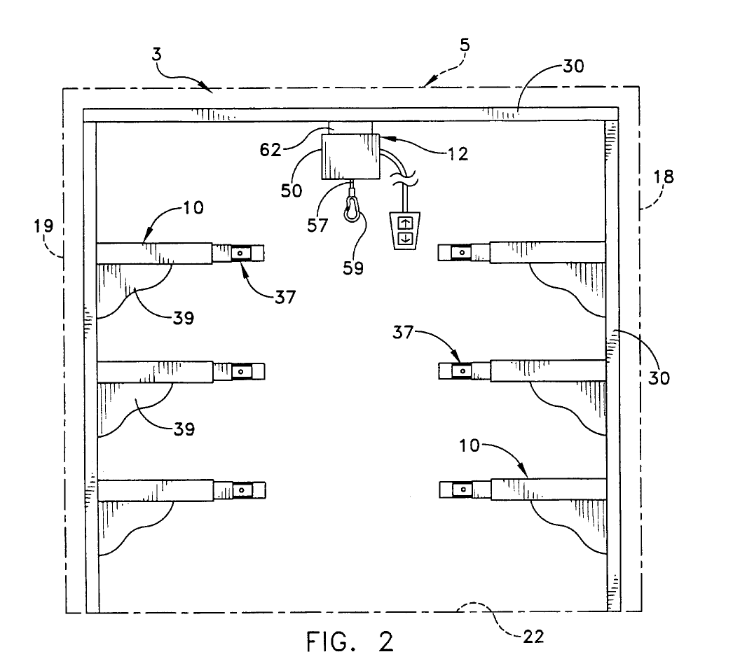

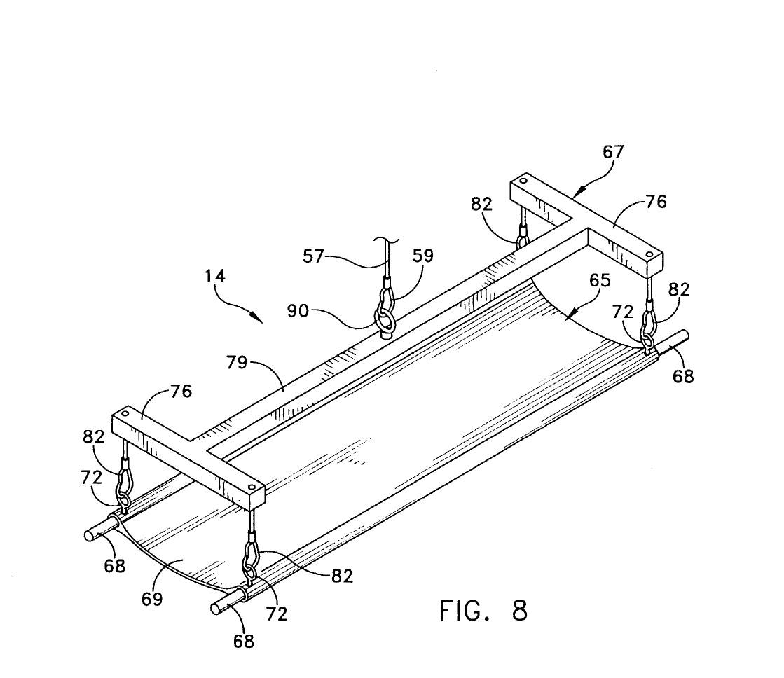

Referring to FIGS. 1 and 2, a cadaver manipulation system 3 for use in a hospital or mortuary refrigerated storage compartment 5 comprises a frame 8, one or more trays 10, a hoist assembly 12, and a sling assembly 14 (FIG. 8). More particularly, a typical refrigerated storage compartment 5 comprises side walls 18,19, a back wall 20, a ceiling 21 and a floor 22. The typical dimensions for a refrigerated storage compartment 5 are about six to eight feet wide, eight to ten feet deep, and seven to nine feet high. A door (not shown) is mounted adjacent to an entrance opening 27 that opposes back wall 20. Frame 8 is positioned within refrigerated storage compartment 5, and includes a plurality of structural support beams 30 arranged and assembled together so as to provide a support skeleton. More particularly, structural support beams 30 are often assembled to form a structure that complements the interior shape of refrigerated storage compartment 5, and that is securely attached to the inner surfaces of side walls 18,19 and floor 22 by fasteners, such as screws, bolts, etc. In some embodiments of the invention, support beams 30 may also extend across ceiling 21 and/or back wall 20. It will be understood that the relative complexity of frame 8 will be influenced by the inherent structural integrity of refrigerated storage compartment 5. Thus, frame 8 may comprise more or less support beams 30, assembled in a variety of arrangements, depending upon the inherent ability of the walls of refrigerated storage compartment 5 to support the loads associated with the present invention.

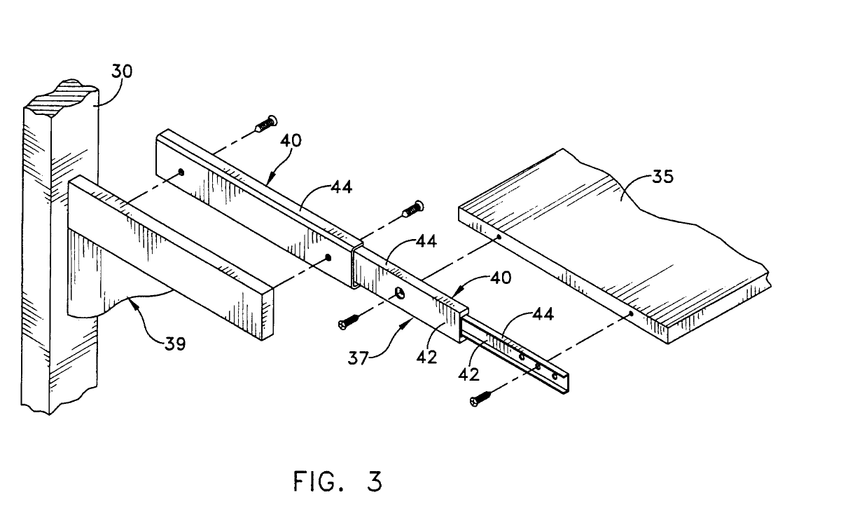

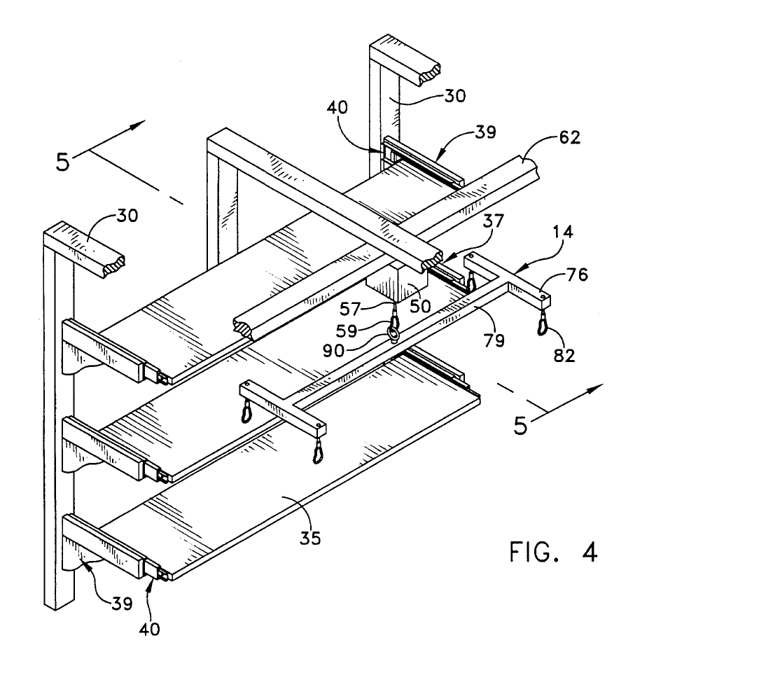

Referring to FIGS. 1-5, one or more trays 10 are supported by structural support beams 30 so as to project inwardly from side walls 18,19. Each tray 10 includes a central support surface 35 that extends between a pair of parallel, telescoping arms 37 that are mounted to spaced-apart brackets 39 (FIGS. 2 and 3). Spaced-apart brackets 39 are each cantilevered to an individual structural support member 30 on a side wall 18,19. Spaced-apart brackets 39 may also be adjustably mounted to beams 30 so that trays 10 may be individually, vertically adjustable to provide for varying distances between adjacent trays and thereby to accommodate different size cadavers within the system of the invention.

Telescoping arms 37 comprise two or more nested, slidingly extensible channel beams 40. Channel beams 40 have a substantially flat web 42 disposed between a pair of inwardly curved, longitudinally extending flanges 44. Flanges 44 are arranged in spaced-apart, confronting relation to one another on the longitudinal edges of web 42. Channel beams 40 are complementarily sized and shaped so as to be assembled one-within-another, with one or more caster bearings, or the like (not shown) positioned between adjacent flanges 44. In this way, as an inner channel beam 40 is slid out from within an outer channel beam, the caster bearings allow the adjacent, nested flanges 44 to slide freely outwardly (or inwardly) relative to one another so that channel beams 40 telescope apart to form a cantilevered support that extends outwardly from side wall 18,19 by a pre-selected distance. In a preferred embodiment, telescoping arms 37 extend about one and a half to about three and a half feet into refrigerated compartment 5.

Referring to FIGS. 1, 2, 4 and 5, hoist assembly 12 is disposed within a protective housing 50 that has the form of a hood that surrounds and protects a conventional hoist mechanism 52. Hoist mechanism 52 will generally include a motor, a drive shaft connected to a rotor shaft of the motor, a reduction gear train for transmitting rotation of the driving shaft to a load sheave, a control unit 55, and a mechanical brake assembly in the reduction gear train. Of course, a manually operated hoist assemble may also be used in connection with the present invention. One or more chains, straps, or cords 57 are engaged with a rotating portion of hoist mechanism 52 so that they can be wound or unwound under the control of control unit 55. Each cord 57 includes a clip, hook, or other releasable clamp 59. Control unit 55 may include conventional control electronics that are operated by manual control switches 60, and serve to regulate the motor speed and accordingly the rate at which cords 57 are wound or unwound by hoist mechanism 52 thereby controlling the lifting speed. Hoist assembly 12 may be movably mounted to a portion of frame 8, or may be a stand alone assembly mounted upon an independent support system. Support beams 30 are sized and shaped to provide sufficient structural support for lifting cadavers within frame 8 for those occasions when hoist assembly 12 is supported by frame 8 In either case, hoist assembly 12 is preferably arranged within refrigerated compartment 5 so as to be capable of moving laterally, i.e., between side walls 18,19, or longitudinally, i.e., between back wall 20 and entrance opening 27, or a combination of both, i.e., in an “X”-“Y” relationship. In this way, hoist assembly 12 may be slid between a variety of positions within refrigerated storage compartment 5.

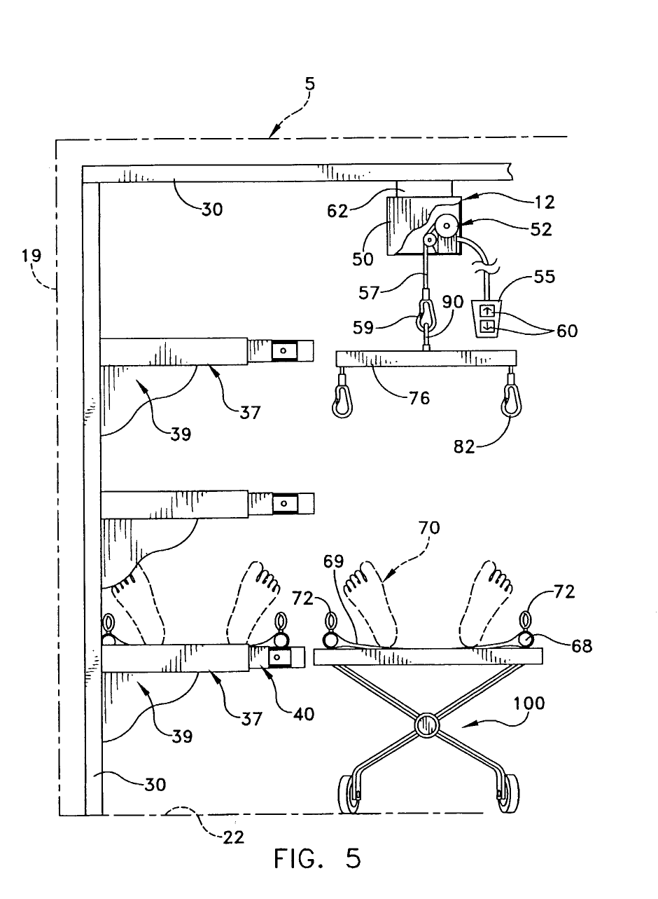

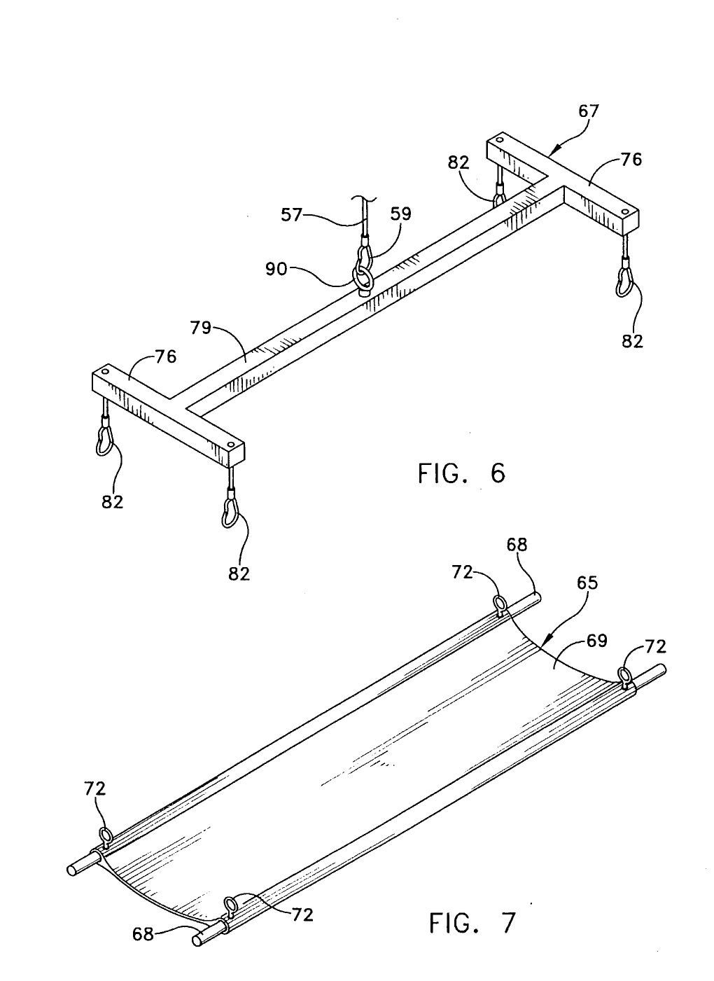

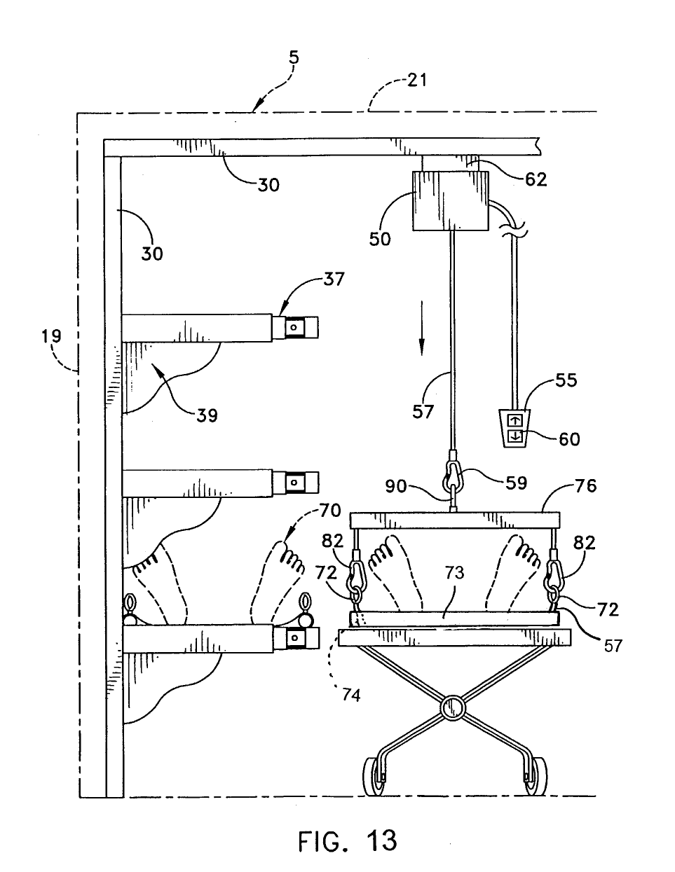

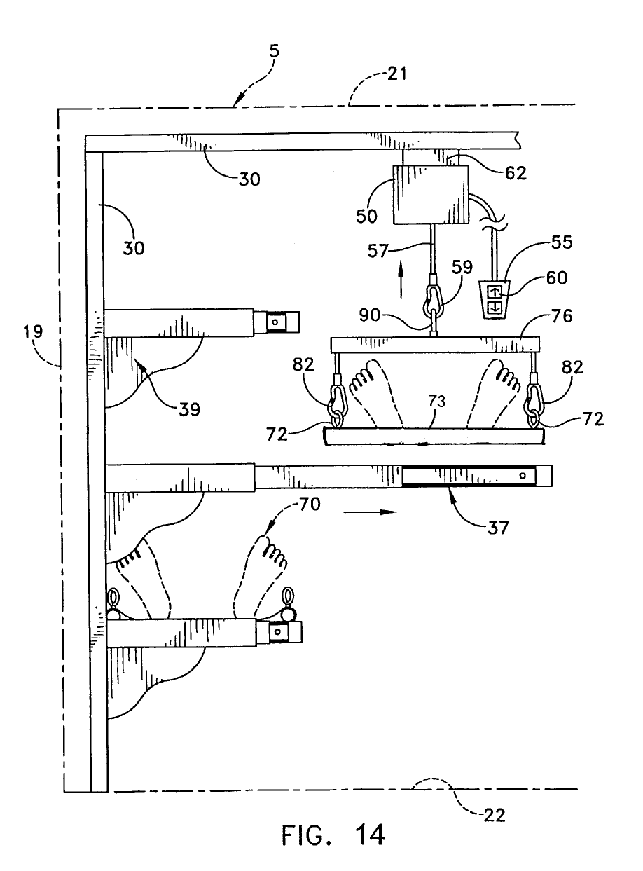

Referring to FIGS. 5-8, sling assembly 14 comprises a pallet 65 and a stabilizing frame 67. In one embodiment, pallet 65 includes at least a pair of spaced-apart, elongate beams 68 arranged so as to support a central bed 69, e.g., a fabric sling, disposable sling, or stiff board that is suitable for supporting a cadaver 70 (FIG. 5). Pallet 65 is sized and shaped to support cadaver 70 along its length and width in a stable condition during transport and manipulation. A plurality of eyelets 72 are often arranged in spaced-apart relation to one another on beams 68, e.g., in the four corners of pallet 65. It will be understood that many other means for clasping or fastening may be used in place of eyelets 72, e.g., a plurality of clamps, holes , clips, etc., as long as they provide means for gripping pallet 65. Alternatively, a standard morgue tray 73 may be used as a pallet (FIGS. 13 and 14). In this embodiment of the invention, cadaver 70 is “log-rolled” onto a standard morgue tray 73, and then transported to refrigerated storage compartment 5 in a conventional manner. Morgue tray 73 includes holes 74 or the like in each of its four corners for engagement with straps or cords 57.

Stabilizing frame 67 often comprises an “H”-shaped beam having at least two cross-members 76 and a longitudinal member 79 that extends between cross-members 76. A plurality of eyelet clips 82 are arranged in spaced-apart relation to one another on cross-members 76, e.g., in the four corners of frame 67, in corresponding relation to eyelets 72. Eyelet clips 82 are complementary to eyelets 72 so that together, they form a releasable fastening mechanism that allows pallet 65 to be releasably fastened to frame 67. It will be understood that many other means for clasping or fastening may be used in place of eyelet clips 82, e.g., a plurality of clamps, hooks, clips, etc., as long as they provide means for gripping pallet 65. An eyelet 90 is positioned in the central portion of longitudinal member 79, and is complementary to clip 59. It will also be understood that stabilizing frame 67 may take other shapes and constructions without departing from the present invention. For example, a pair of longitudinal members may be joined along a portion of their length, with the remaining portions being flared outwardly so as to form a substantially “X” shaped stabilizer.

Cadaver manipulation system 3 may be assembled in a typical hospital morgue or mortuary refrigerated storage compartment 5 by assembling frame 8 so that structural support beams 30 form a support skeleton within refrigerator storage compartment 5. It will be understood that frame 8 need only be assembled adjacent to side walls 18,19. In one construction, a longitudinally extending central support beam 62 extends from rear wall 20 to front wall 22 so as to provide a track for protective housing 50 of hoist assembly 12 to slide along so as to be positioned anywhere within frame 8 between the front and rear walls. In another construction, central support beam 62 extends laterally between side walls 18,19 so as to provide a track for protective housing 50 of hoist assembly 12 to slide along so as to be positioned anywhere within frame. A plurality of telescoping arms 37 are then assembled to brackets 39 on support beams 30 so that a pair of telescoping arms 37 are arranged in parallel, spaced relation to one another, and project inwardly, into the central portion of refrigerated storage compartment 5.

In one embodiment of the invention, an individual tray 10 is then mounted on each pair of telescoping arms 37 to complete the assembly. In this way, a plurality of trays 10 are stacked one above another on both sidewalls 18,19. In the alternative embodiment shown in FIGS. 13 and 14, plurality of telescoping arms 37 are assembled to brackets 39 on support beams 30 so that each pair of telescoping arms 37 are arranged in parallel, spaced relation to one another awaiting the loading of a morgue tray 73 carrying a cadaver 70. In either alternative embodiment, brackets 39 may be movably mounted to structural support beams 30 so as to be adjustable. This construction allows for a variable height between adjacent trays 10.

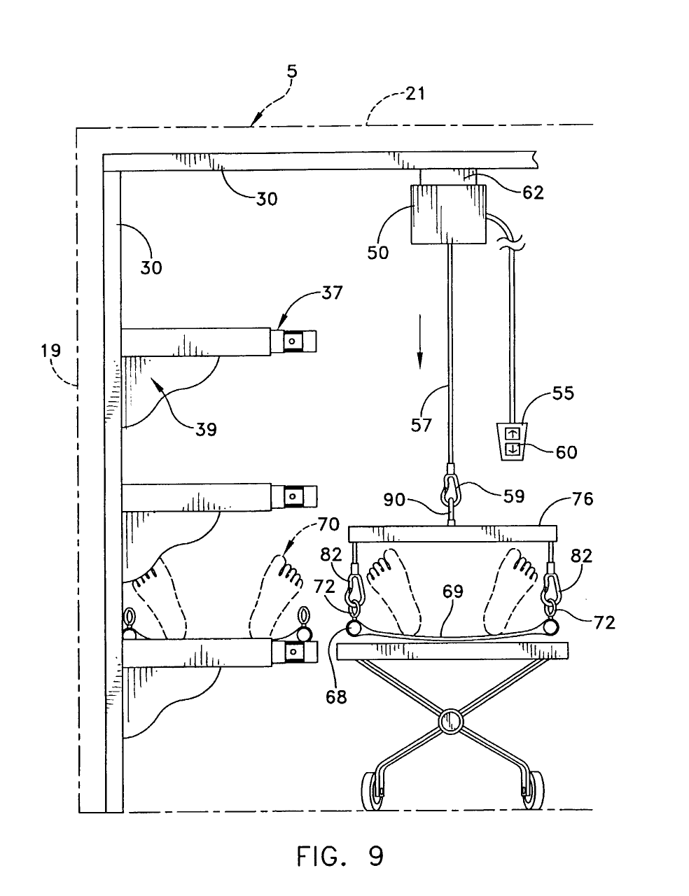

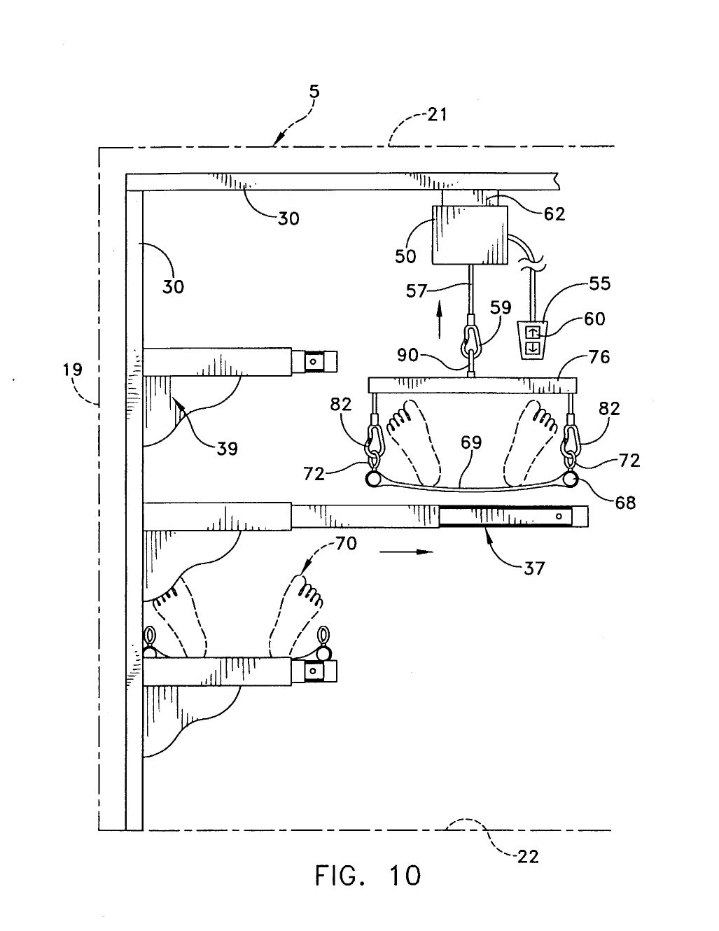

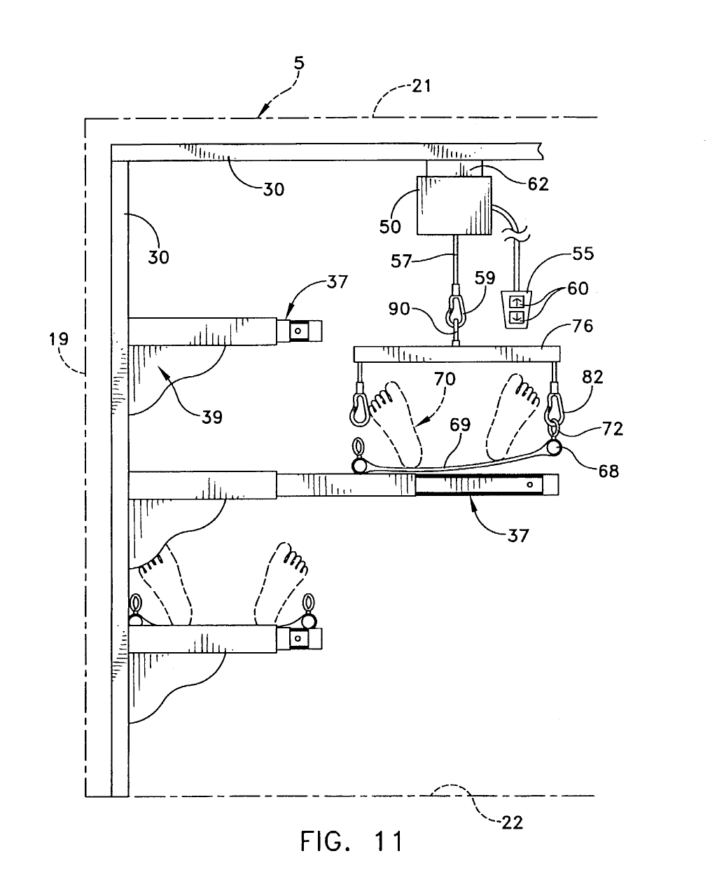

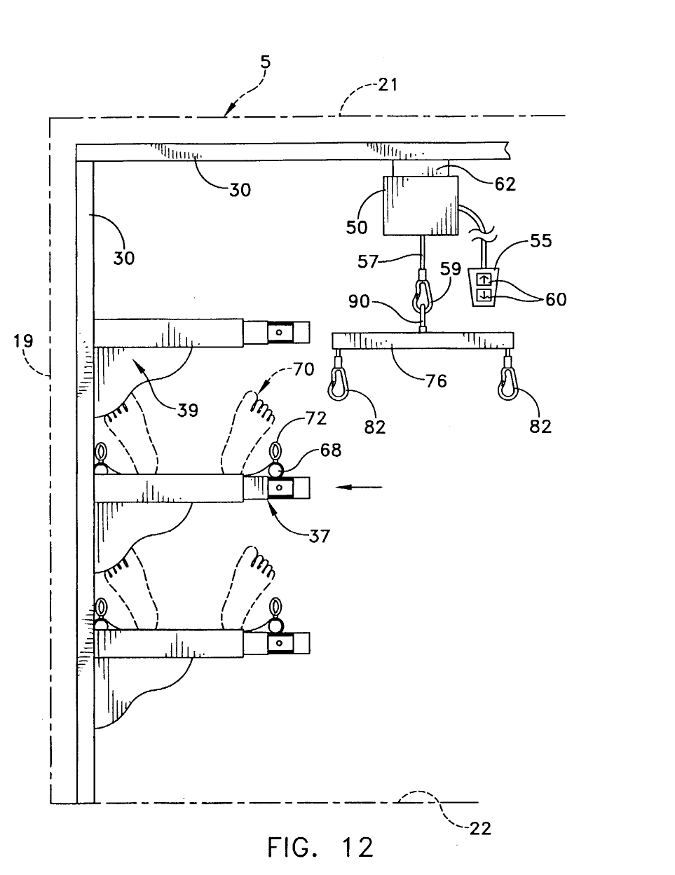

Cadaver manipulation system 3 provides a method for manipulating cadavers within refrigerated storage compartment 5 in the following manner. A cadaver 70 is positioned on pallet 65 or morgue tray 73 which, in turn, is placed on top of a transport cart 100. Cart 100 is then wheeled into frame 8 within refrigerated storage compartment 5 so that cadaver 70 on pallet 65 or morgue tray 73 is positioned in adjacent parallel relation to plurality of telescoping arms 37. Hoist assembly 12 has sling assembly 14 fastened to it by first engaging clip 59 in eyelet 90 of frame 67. Once in this position, hoist assembly 12 is activated by engaging manual control switch 60 so as to lower cord 57 and frame 67 toward cadaver 70 (FIG. 9). Frame 67 is lowered toward pallet 65 until eyelet clips 82 are able to engage eyelets 72 on pallet 65 or holes 74 in the corners of morgue tray 73. Once in this position, control unit 55 is again activated by pressing manual control switch 60 so as to cause hoist mechanism 52 to reel in cord 57 thereby lifting sling assembly 14 into position adjacent to, but slightly above either an empty tray 10 (FIGS. 10 and 11), or a pair of parallel telescoping arms 37 (FIGS. 13 and 14).

Once in this position, extendible telescoping arms 37 are extended outwardly away from sidewall 18 or 19 so as to be positioned below pallet 65 or morgue tray 73. From here, hoist assembly 12 is once again activated so as to lower sling assembly 14 toward extended, parallel telescoping arms 37. Once pallet 65 or morgue tray 73 and cadaver 70 are fully seated upon parallel telescoping arms 37, eyelet clips 82 are unclamped from eyelets 72 so as to allow cadaver 70 to be positioned at rest. Morgue tray 73 or tray 10 are then pushed toward its respective sidewall 18 or 19 so that telescoping arms 37 collapse so as to position cadaver 70 against or adjacent to frame 30. In order to remove cadaver 70, the foregoing procedure is simply reversed.

It is to be understood that the present invention is by no means limited only to the particular constructions herein disclosed and shown in the drawings, but also comprises any modifications or equivalents within the scope of the claims.

What is claimed is:

1. A system for manipulating cadavers in a storage compartment comprising:
a frame erected within said storage compartment;
a plurality of trays supported by said frame so as to project inwardly into said storage compartment wherein each of said trays is supported by a pair of spaced-apart telescoping arms so that each tray can be moved between (i) a first position wherein said telescoping arms supporting said tray are fully retracted, and (ii) a second position wherein said telescoping arms supporting said tray are fully extended; and
a hoist assembly arranged within said storage compartment so as to raise a cadaver above said pair of spaced-apart telescoping arms when said tray is in said first position, and lower said cadaver onto said tray when said tray is in said second position.

2. A system according to claim 1 wherein each of said trays includes a central support surface that extends between a pair of parallel, telescoping arms that are mounted to spaced-apart beams in said frame.

3. A system according to claim 2 wherein each of said pair of parallel telescoping arms is supported by a bracket that is cantilevered to a beam in said frame.

4. A system according to claim 1 wherein each of said telescoping arms comprise at least two nested, slidingly extensible channel beams.

5. A system according to claim 4 wherein each of said at least two nested channel beams comprise a substantially flat web disposed between a pair of inwardly curved, longitudinally extending flanges arranged in spaced-apart, confronting relation to one another.

6. A system according to claim 4 wherein said channel beams telescope apart to form a cantilevered support that extends into said compartment.

7. A system according to claim 1 wherein said hoist assembly comprises one or more cords that are under operative control of a control unit so as to raise and lower said cords relative to said trays.

8. A system according to claim 7 wherein said cord includes a releasable clamp.

9. A system according to claim 7 wherein said hoist assembly comprises a control unit including control electronics that are operated by manual control switches, and serve to power a motor and thereby a rate at which said cord is raised and lowered.

10. A system according to claim 1 wherein said hoist assembly is slidingly mounted to a support beam that extends at least one of laterally and longitudinally along a ceiling portion of said frame such that said hoist assembly may be slid through multiple positions relative to said frame.

11. A system according to claim 1 wherein said cadaver is supported by a sling assembly comprising at least a pair of spaced-apart, elongate beams arranged so as to support a central bed that is sized and shaped to support said cadaver, and a sling frame having at least two cross-members and a longitudinal member that extends between said cross-members.

12. A system according to claim 11 wherein said beams include a plurality of eyelets arranged in spaced-apart relation to one another.

13. A system according to claim 12 wherein said sling frame includes a plurality of eyelet clips arranged in spaced-apart relation to one another on said cross-members, in corresponding relation to said eyelets wherein said eyelet clips are complementary to said eyelets so that together they form a releasable fastening mechanism that allows said beams to be releasably fastened to said sling frame.

14. A system according to claim 13 wherein said frame includes an eyelet positioned in a central portion of said longitudinal member.

15. A cadaver storage system comprising:
a refrigerated compartment;
a frame erected within said refrigerated compartment so as to form an internal structural skeleton on at least a portion of the interior surfaces of the walls of said refrigerated compartment;
a plurality of trays cantilevered to said structural skeleton so as to project inwardly into said refrigerated compartment wherein each of said trays is mounted upon a pair of spaced-apart telescoping arms so that each tray can be moved between (i) a first position wherein said telescoping arms are fully retracted, and (ii) a second position wherein said telescoping arms are fully extended; and
a hoist assembly slidingly supported by a support beam mounted to said structural skeleton, said hoist assembly being slidably arranged on said support beam so as to raise a cadaver above said tray when said tray is in said first position, and lower said cadaver onto said tray when said tray is in said second position.

16. A system according to claim 15 wherein each of said trays includes a central support surface that extends between a pair of parallel, telescoping arms that are mounted to spaced-apart portions of said structural skeleton.

17. A system according to claim 16 wherein each of said telescoping arms comprises at least two nested channel beams comprising a substantially flat web disposed between a pair of inwardly curved, longitudinally extending flanges arranged in spaced-apart, confronting relation to one another.

18. A system according to claim 17 wherein said channel beams telescope apart to form a cantilevered support that extends into said refrigerated compartment by a preselected distance.

19. A system according to claim 15 wherein said hoist assembly is operative to raise and lower at least one cord that is releasably connected to said trays.

20. A system according to claim 19 wherein said at least one cord includes a releasable clamp.

21. A system according to claim 15 wherein said cadaver is supported by a sling assembly comprising at least a pair of spaced-apart, elongate beams arranged so as to support a central bed that is sized and shaped to support said cadaver, and a sling frame having at least two cross-members and a longitudinal member that extends between said cross-members.

22. A system according to claim 21 wherein said beams include means for fastening arranged in spaced-apart relation to one another.

23. A system according to claim 22 wherein said sling frame includes means for clipping arranged in spaced-apart relation to one another on said cross-members, in corresponding relation to said fastening means wherein said means for clipping are complementary to said means for fastening so that together said beams may be releasably fastened to said sling frame.

24. A system according to claim 23 wherein said sling frame includes an eyelet positioned in a central portion of said longitudinal member.

25. A system according to claim 15 wherein said trays are vertically adjustable so as to provide for varying distances between adjacent trays.

26. A system according to claim 15 wherein said cadaver is supported by a sling assembly comprising a disposable central bed that is sized and shaped to support said cadaver.

27. A system for manipulating cadavers in a storage compartment comprising:
a frame erected within said storage compartment;
a plurality of spaced-apart telescoping arms supported by said frame so that each of said arms can move into a central portion of said storage compartment;
at least one tray supported by a pair of spaced-apart telescoping arms so that when supported by said arms, said at least one tray can be moved between (i) a first position wherein said telescoping arms are fully retracted, and (ii) a second position wherein said telescoping arms are fully extended; and
a hoist assembly supported by said frame and arranged so as to raise a cadaver positioned upon said tray when said telescoping arms are in said first position, and lower said cadaver and said tray onto said telescoping arms when said telescoping arms are in said second position.

28. A method for manipulating a cadaver comprising:
(A) positioning a cadaver on a pallet for transportation to a storage compartment;
(B) lifting said cadaver and pallet within said storage compartment to a position above a tray;
(C) pulling on said tray so as to extend a pair of telescoping arms supporting said tray to a position substantially under said pallet;
(D) lowering said pallet onto said tray; and
(E) pushing on said tray so as to collapse said telescoping arms supporting said tray.

29. A method according to claim 28 wherein a second cadaver is positioned on a second pallet for transportation to said storage compartment;
said second cadaver and pallet are lifted within said storage compartment to a position above a second tray;
said second tray is pulled so as to extend a pair of telescoping arms supporting said second tray to a position substantially under said second pallet;
said pallet is lowered onto said second tray; and
said second tray is pushed so as to collapse said telescoping arms supporting said second tray.

30. A method according to claim 29 wherein said steps are repeated until a plurality of trays each support a cadaver.

31. A method for manipulating a cadaver comprising:
(A) positioning a cadaver on a morgue tray for transportation to a storage compartment;
(B) lifting said cadaver and said morgue tray within said storage compartment to a position above a pair of telescoping arms;
(C) pulling on said pair of telescoping arms so as to extend them to a position substantially under said morgue tray;
(D) lowering said morgue tray onto said pair of telescoping arms; and
(E) pushing on said pair of telescoping arms so as to collapse said telescoping arms supporting said tray.
